(19) United States
(12) Patent Application Publication
(10) Pub. No.: US 2026/0001095 A1
(43) Pub. Date: Jan. 1, 2026

(54) APPLICATION DEVICE, PRODUCTION DEVICE FOR PRODUCING AT LEAST PARTIALLY COATED AND/OR IMPREGNATED PRODUCTS, AND METHOD FOR CLEANING AN APPLICATION DEVICE FOR A COATING AGENT OR IMPREGNATION AGENT BY MEANS OF A CLEANING UNIT

(71) Applicant: JOSEF SCHIELE, Niederzissen (DE)

(72) Inventors: Stefan Schiele, Niederzissen (DE); Matthias Gros, Niederzissen (DE)

(21) Appl. No.: 18/874,940

(22) PCT Filed: Jun. 14, 2023
(86) PCT No.: PCT/EP2023/066012

§ 371 Date: Dec. 13, 2024

(30) Foreign Application Priority Data
Jun. 15, 2022 (DE) 10 2022 206 048.2

(51) Int. Cl. B05C 1/08; B08B 1/12; B08B 1/16; B08B 1/50; B08B 3/02

(52) U.S. Cl. CPC B05C 1/0817; B08B 1/12; B08B 1/165; B08B 1/50; B08B 3/02

(57) ABSTRACT

The present invention relates to an application device (1), comprising: an application unit (2) for a coating agent or impregnation agent, wherein the application unit (2) has a container (22) for the coating agent or impregnation agent and has a transfer wheel (21) rotatably arranged in the container (22), wherein part of the transfer wheel (21), in particular a circle segment of the transfer wheel (21), protrudes out of a container opening of the container (21); and a cleaning unit (3), which has a hood (31) which is designed to cover the container opening of the container (22) during a cleaning process, wherein the hood (31) has a receiving region (32) for receiving the part of the transfer wheel (21) protruding out of the container opening; and a drive unit (5) and a holder (4), on which the application unit (2) and the cleaning unit (3) are arranged so as to be movable relative to one another by means of the drive unit (5), wherein the application unit (2) and the cleaning unit (3) can be moved relative to one another between a cleaning position, in which the hood (31) of the cleaning unit (3) covers the container opening of the application unit (2), and a production position, in which the hood (31) of the cleaning unit (3) is arranged at a distance from the container opening of the application unit (2).

The present invention relates to an application apparatus, comprising an application unit for applying a coating agent or impregnation agent, the application unit having a container for a coating agent or impregnation agent and a transfer wheel rotatably arranged in the container, wherein a part of the transfer wheel, in particular a circular segment of the transfer wheel, protrudes out of an opening of the container. The invention also relates to a production apparatus for producing at least partially coated and/or impregnated products, in particular floor elements. The invention further relates to a method for cleaning, by means of a cleaning unit, an application unit for applying a coating agent or impregnation agent.

Such application apparatuses are used for example in production apparatuses for producing at least partially coated and/or impregnated floor elements in order for a portion of the floor elements, such as joining surfaces or chamfers, to be coated, or provided with a non-layer-forming impregnation agent. The coating agent or impregnation agent is generally taken up from a container by a rotating transfer wheel and the layer thickness is set on the transfer wheel by means of a scraper. The floor element to which the agent is applied is typically moved relative to the transfer wheel by a conveying apparatus. The transfer wheel transfers the coating agent or impregnation agent to the respective portion of the moving floor element. The application is generally done contactlessly, solely by adhesion forces. In this context, contactless means that the transfer wheel does not make contact with the workpiece, but the coat of lacquer applied to the transfer wheel does.

The availability of the transfer wheel drops in principle as the operating duration increases, owing to impurities that accumulate in the coating agent or impregnation agent or on the scraper such that it is necessary to regularly clean the application unit. Such cleaning measures can, however, be carried out only while the entire production apparatus is at a standstill.

Against this background, the object is to increase the availability of a production apparatus for producing at least partially coated and/or impregnated products, such as floor elements.

What is proposed to achieve this object is an application apparatus comprising
an application unit for applying a coating agent or impregnation agent, the application unit comprising a container for a coating agent or impregnation agent and a transfer wheel rotatably arranged in the container, wherein a part of the transfer wheel, in particular a circular segment of the transfer wheel, protrudes out of a container opening, and
a cleaning unit, which includes a hood designed to cover the opening of the container during a cleaning operation, the hood having a receiving region for receiving that part of the transfer wheel that protrudes out of the container opening, and
a drive unit and a mount, on which the application unit and the cleaning unit are arranged movably relative to one another by means of the drive unit, the application unit and the cleaning unit being movable relative to one another between a cleaning position, in which the hood of the cleaning unit covers the container opening of the application unit, and a production position, in which the hood of the cleaning unit is away from the container opening of the application unit.

The application apparatus according to the invention offers the advantage that the application unit, in particular the transfer wheel and the container, can be cleaned in automated fashion, without it being necessary for an operator to intervene. The application unit can be cleaned in automated fashion while a production apparatus comprising the application apparatus is at a standstill, which is to say for example while an operator of the production apparatus is performing maintenance on it. The cleaning unit and the application unit can be moved by means of the drive unit relative to one another from the production position into the cleaning position. In the cleaning position, the hood of the cleaning unit covers the container opening of the application unit and the receiving region of the hood receives a part of the transfer wheel, with the result that the container and the transfer wheel can be cleaned without adversely affecting the surrounding area.

According to the invention, the application unit and the cleaning unit are arranged on the mount movably relative to one another by means of the drive unit. When there is a transition between the production position of the two units and the cleaning position, either the cleaning unit can be moved relative to the application unit or the application unit can be moved relative to the cleaning unit. As a further alternative, it may be provided that both the application unit and the cleaning unit move relative to the mount and to one another, in order to pass from the production position to the cleaning position.

With preference, the cleaning unit is arranged lower down with respect to the direction of gravitational force in the cleaning position than in the production position.

As an alternative or additionally, it may be provided that the cleaning unit is offset in a horizontal direction, which extends perpendicularly in relation to the direction of gravitational force, in the cleaning position in comparison with the production position.

As an alternative or additionally, the application unit may be arranged higher up with respect to the direction of gravitational force in the cleaning position than in the production position.

According to an advantageous configuration of the invention, it is provided that the application apparatus has a first triggering device for triggering a movement of the application unit and/or the cleaning unit toward the cleaning position and optionally a cleaning operation, the first triggering device being a first actuation apparatus, which can be actuated by a user. An operator of the application apparatus can use the first triggering apparatus, which is in the form of an actuation apparatus, to manually start a cleaning operation, for example whenever the application apparatus or the production apparatus containing the application apparatus is at a standstill. The actuation apparatus may be in the form of a switch or pushbutton. The actuation apparatus may be arranged inside a housing or on a frame of the application apparatus. As an alternative, the actuation apparatus may be separate from a housing or frame of the application apparatus and be connected to the application apparatus via a wired or wireless communications connection. As an alternative, it may be provided that the triggering device is a first evaluation apparatus, which is designed to detect a specified state, in particular a maintenance state. The evaluation apparatus may receive a signal from a further apparatus, for example a controller of a production apparatus, and detect the specified state on the basis of this signal. As an alternative, the evaluation apparatus can monitor the further apparatus of the production apparatus, in order to detect the specified state.

According to an advantageous configuration of the invention, it is provided that the receiving region of the hood contains two cleaning elements, which are arranged in such a way that that part of the transfer wheel that protrudes out of the container opening is arranged between the two cleaning elements when the hood covers the container opening, with the result that one of the two cleaning elements can clean a respective one of two oppositely situated surfaces of the transfer wheel. In this respect, the cleaning elements may be situated opposite one another and enclose the transfer wheel between them. With preference, the cleaning elements are arranged on two oppositely situated inner walls of the hood. As an alternative, the cleaning elements may be arranged within the receiving region at a spacing from the inner walls of the hood.

According to an advantageous configuration of the invention, it is provided that the two cleaning elements are in the form of brushes of the same type. The cleaning elements in the form of brushes make it possible to mechanically clean the transfer wheel. As an alternative, the two cleaning elements may be in the form of spray elements, in particular spray elements of the same type. The cleaning elements in the form of spray elements enable wet cleaning of the transfer wheel. With preference, the cleaning unit, besides the two cleaning elements, comprises further cleaning elements, for example further spray elements. The further spray elements may be arranged in an upper portion of the receiving region, such that a cleaning liquid, for example water, can be applied by or to the transfer wheel and collected in the container of the application unit. The further cleaning elements may comprise in particular one or more rotatable spray elements which can discharge cleaning liquid in various spatial directions within the receiving region.

Optionally, one or more cleaning elements may be arranged within the container for coating agents or impregnation agents. These cleaning elements may be in the form of brushes and/or spray elements.

According to an advantageous configuration of the invention, it is provided that the application unit has a scraper for scraping a coating agent or impregnation agent from the transfer wheel, the scraper being arranged inside the container, wherein the cleaning unit has a further cleaning element, in particular a spray element, which is arranged in the receiving region of the hood in such a way that it can clean the scraper when the hood covers the container opening. The further cleaning element for cleaning the scraper is preferably a rotatable spray element, via which cleaning liquid can be discharged in various spatial directions within the receiving region.

With preference, the further cleaning element for cleaning the scraper can be brought from a retracted inactive position into an extended cleaning position. For instance, the further cleaning element can remain for example in the inactive position when the cleaning unit and the application unit are moved relative to one another. After the cleaning unit and application unit have been coupled, the further cleaning element may be brought out of the inactive position into the cleaning position, in order to clean the scraper. With preference, the further cleaning element in the cleaning position is arranged underneath, or obliquely underneath, the scraper in the direction of gravitational force, with the result that the scraper can be cleaned from underneath. As the transfer wheel rotates, typically more coating agent or sealing agent, including the dirt particles that agent contains, is applied to the underside of the scraper, resulting in more adhesive attachments occurring on this underside.

Optionally, a scraping tool, in particular a blade, may be provided on the scraper, the scraper being movable relative to the scraping tool for the purpose of cleaning the scraper. The relative movement of the scraper and scraping tool may be driven manually or by a motor. To clean adhesive attachments off of the scraper, the latter can be moved relative to the scraping tool, with the result that the scraping tool scrapes the adhesive attachments off of the scraper. As an alternative, the scraping tool may be moved relative to the scraper. With preference, the scraping tool is arranged underneath the scraper in the direction of gravitational force, with the result that the underside of the scraper can be cleaned.

An advantageous configuration of the invention provides that the container of the application unit has a side wall, which delimits and encircles the container opening, and a bottom which is fixedly connected to the side wall and is arranged on the oppositely situated end of the side wall to the container opening. Such a configuration offers the advantage that the container can be completely closed by the hood of the cleaning device.

An alternatively preferred configuration provides that the container of the application unit has a bottom opening and a bottom which can be opened to clear the bottom opening, the cleaning unit having a bottom element which can be moved independently of the hood, is away from the application unit in the production position, and covers the bottom opening in the cleaning position. Such a configuration offers the option of bringing elements of the cleaning unit into contact with the container via two openings of the container, specifically via the container opening and the bottom opening. In such a configuration, the container can be completely closed by the hood of the cleaning device and by the movable bottom element.

To achieve the object mentioned at the outset, also proposed is a production apparatus for producing at least partially coated and/or impregnated products, in particular floor elements,
comprising an application apparatus as described above and
comprising a first processing apparatus for processing the products and
comprising a conveying apparatus for conveying the products from the first processing apparatus to the application apparatus or a conveying apparatus for conveying the products from the application apparatus to the first processing apparatus,
and comprising, intended as part of the first processing apparatus, a second triggering device for triggering a movement of the application unit and/or the cleaning unit toward the cleaning position and optionally a cleaning operation,
the second triggering device being a second actuation apparatus, which can be actuated by a user, or a second evaluation apparatus, which is designed to detect a specified state, in particular a maintenance state, of the first processing apparatus.

The second triggering device makes it possible to initiate a cleaning operation for cleaning the application unit from outside the application apparatus. In the case of a second triggering apparatus in the form of an actuation apparatus, an operator of the production apparatus can manually start the cleaning operation on the application unit from the position of the first processing apparatus, for example whenever the operator is performing maintenance on the first processing apparatus and therefore this or the entire production apparatus is at a standstill. As an alternative, it may be provided that the second triggering device is a second evaluation apparatus, which is designed to detect a specified state, in particular a maintenance state, of the first processing apparatus. The evaluation apparatus may receive a signal from the first processing apparatus, for example a controller of the first processing apparatus, and detect the specified state on the basis of this signal. As an alternative, the second evaluation apparatus can monitor the first processing apparatus, in order to detect the specified state.

The first processing apparatus may be in the form for example of a milling apparatus, drying apparatus or a further application apparatus. The floor elements may be in the form of floorboards. The conveying apparatus may be a conveyor belt or a conveying chain.

According to an advantageous configuration of the invention, it is provided that the production apparatus comprises at least one second processing apparatus for processing the products, which has, intended as part of the second processing apparatus, a third triggering device for triggering a movement of the application unit and/or the cleaning unit toward the cleaning position and optionally a cleaning operation, the third triggering device being a third actuation apparatus, which can be actuated by a user, or a third evaluation apparatus, which is designed to detect a specified state, in particular a maintenance state, of the second processing apparatus. In this respect, it is possible to provide multiple triggering devices which are provided outside the application apparatus and via which a cleaning operation on the application unit can optionally be initiated.

According to an advantageous configuration of the invention, it is provided that the application apparatus has a supply unit for supplying the application unit with a coating agent or impregnation agent.

In this context, it is advantageous if the application unit is connected to the supply unit via a supply line, in particular a branch line, or via multiple supply lines, in particular a feed line and a return line.

According to an advantageous configuration of the invention, it is provided that
the application apparatus has a first triggering device for triggering a movement of the application unit and/or the cleaning unit toward the cleaning position and optionally a cleaning operation, the first triggering device being a first actuation apparatus, which can be actuated by a user, or a first evaluation apparatus, which is designed to detect a specified state, in particular a maintenance state,
the application apparatus has a supply unit for supplying the application unit with a coating agent or impregnation agent, and
the production apparatus, in particular a controller of the production apparatus, is designed
   to, when the first triggering device is triggered, bring the application unit and/or the cleaning unit into the cleaning position, initiate a cleaning operation on the application unit, and initiate a cleaning operation on the supply unit and/or initiate a coating-agent or impregnation-agent exchanging operation in the supply unit and
   to, when the second triggering device is triggered, bring the application unit and/or the cleaning unit into the cleaning position, initiate a cleaning operation on the application unit, and not initiate a cleaning operation on the supply unit.

Such a configuration of the invention offers the advantage that, by triggering the first triggering device provided on the application apparatus, the application apparatus is completely cleaned, but when the second triggering device is used for the triggering only part of the application apparatus is cleaned, and that cleaning can be carried out in a short period of time and/or with little effort. This partial cleaning can be done without manual intervention by an operator, in the manner of an interim cleaning, and commenced in particular whenever maintenance or repair measures need to be carried out somewhere different than the production apparatus, in particular somewhere different than the application apparatus. The partial cleaning makes it possible to ensure that the application apparatus is in a cleaned state when the production apparatus is started up again. During maintenance or repair work on the application apparatus or when there is a job change, it is possible to use the first triggering device to commence, by contrast, a complete cleaning. The complete cleaning may involve the cleaning of the transfer wheel, the container, a possibly present scraper, a possibly present buffer container, any lines connected to the container, the supply unit, and lines between the supply unit and the application unit.

The supply unit may have a first suction unit for drawing in a coating agent or impregnation agent from a first container for medium, a second suction unit for drawing in a coating agent or impregnation agent from a second container for medium, and a cleaning station for cleaning the first or second suction unit. The first and the second suction unit preferably each comprise a suction lance and a cover for closing the respective container for medium. The cleaning station may comprise a receptacle for a suction unit, in particular for a suction lance of a suction unit. Arranged in the region of the receptacle are preferably one or more cleaning nozzles, via which a suction unit or suction lance received in the receptacle can be cleaned.

Another subject of the invention is a method for cleaning, by means of a cleaning unit, an application unit for applying a coating agent or impregnation agent,
the application unit comprising a container for the coating agent or impregnation agent and a transfer wheel rotatably arranged in the container, wherein a part of the transfer wheel, in particular a circular segment of the transfer wheel, protrudes out of an opening of the container,
the cleaning unit comprising a hood designed to cover the opening of the container during a cleaning operation, the hood having a receiving region for receiving that part of the transfer wheel that protrudes out of the container opening,
the application unit and the cleaning unit being arranged, in particular on a mount, movably relative to one another, in particular via a drive unit, the application unit and the cleaning unit being movable relative to one another from a production position, in which the hood of the cleaning unit is away from the container opening of the application unit, and a cleaning position, in which the hood of the cleaning unit covers the container opening of the application unit.

In the case of the method, the same advantages can be achieved as have already been described in connection with the application device according to the invention and the production apparatus.

It is possible within the scope of the method according to the invention that, on transition into the cleaning position, the application unit is moved and the cleaning unit is not moved or the cleaning unit is moved and the application unit is not moved. As a further alternative, it is possible that, on transition into the cleaning position, both the application unit and the cleaning unit are moved.

With preference, the cleaning unit, proceeding from the production position, is moved in such a way that it is arranged lower down with respect to the direction of gravitational force in the cleaning position than in the production position. As an alternative or additionally, it may be provided that the cleaning unit, proceeding from the production position, is moved in such a way that it is offset in a horizontal direction, which extends perpendicularly in relation to the direction of gravitational force, in the cleaning position in comparison with the production position.

According to an advantageous configuration of the invention, proceeding from the production position—in a first movement step—first of all the application unit is moved in such a way that the application unit clears a space taken up by the application unit in the production position. The cleaning unit is thereupon—in a second movement step—moved into the space cleared by the application unit, in particular in a horizontal direction, which extends perpendicularly in relation to the direction of gravitational force. In a subsequent third movement step, the application unit is then moved up to the cleaning unit such that the cleaning unit and the application unit assume the cleaning position (in which the hood of the cleaning unit covers the container opening of the application unit). Such a configuration is suitable in particular for such use cases in which, owing to design constraints on the application apparatus, it is not possible to move the cleaning unit up to the application unit without the application unit being moved out of the production position. For example, a conveying apparatus of the application unit may be arranged above the application unit and prevent the cleaning unit from approaching the application unit from above.

According to an advantageous configuration of the method, it is provided that the movement toward the cleaning position is triggered by a first actuation apparatus, which is actuated by a user, or by a first evaluation apparatus, which detects a specified state, in particular a maintenance state, of the application apparatus and/or of a processing apparatus which, together with the application apparatus, is part of a common production plant, in particular for producing coated or impregnated products, for example floor elements.

According to an advantageous configuration of the method, it is provided that the receiving region of the hood contains two cleaning elements, which are arranged in such a way that that part of the transfer wheel that protrudes out of the container opening is arranged between the two cleaning elements when the hood covers the container opening, with the result that one of the two cleaning elements cleans a respective one of two oppositely situated surfaces of the transfer wheel. With preference, the two cleaning elements are in the form of brushes, in particular brushes of the same type. The cleaning elements in the form of brushes make it possible to mechanically clean the transfer wheel. As an alternative, the two cleaning elements may be in the form of spray elements, in particular spray elements of the same type. The cleaning elements in the form of spray elements enable wet cleaning of the transfer wheel. With preference, the cleaning unit, besides the two cleaning elements, comprises further cleaning elements, for example further spray elements. The further spray elements may be arranged in an upper portion of the receiving region, such that a cleaning liquid, for example water, can be applied by or to the transfer wheel and collected in the container of the application unit. The further cleaning elements may comprise in particular one or more rotatable spray elements which can discharge cleaning liquid in various spatial directions within the receiving region.

According to an advantageous configuration of the method, it is provided that the application apparatus has a supply unit for supplying the application unit with a coating agent or impregnation agent, a cleaning operation on the supply unit being initiated together with the movement of the application unit and of the cleaning unit relative to one another into the cleaning position. With preference, a cleaning operation on one or more connecting lines that connect the cleaning unit and the application unit is initiated together with the initiation of the cleaning operation on the supply unit. With preference, it is provided that the cleaning operation on the supply unit is optionally initiated together with the movement of the application unit and the cleaning unit relative to one another into the cleaning position. In this respect, it is preferable if it is possible to select either exclusive cleaning of the application unit (by moving the application unit and the cleaning unit relative to one another into the cleaning position) or cleaning of the application unit together with the supply unit (and, if appropriate, the connecting lines). This selection can be made via a man/machine interface, which comprises for example one or more actuation devices.

According to an advantageous configuration of the method, it is provided that the application apparatus has a supply unit for supplying the application unit with a coating agent or impregnation agent, a coating-agent or impregnation-agent exchanging operation in the supply unit being initiated together with the movement of the application unit and of the cleaning unit relative to one another into the cleaning position. With preference, a cleaning operation on one or more connecting lines that connect the cleaning unit and the application unit is initiated together with the initiation of the coating-agent or impregnation-agent exchanging operation. With particular preference, a cleaning operation on the supply unit follows the coating-agent or impregnation-agent exchanging operation. With preference, it is provided that the coating-agent or impregnation-agent exchanging operation is optionally initiated together with the movement of the application unit and the cleaning unit relative to one another into the cleaning position. In this respect, it is preferable if it is possible to select either exclusive cleaning of the application unit (by moving the application unit and the cleaning unit relative to one another into the cleaning position) or cleaning of the application unit together with a coating-agent or impregnation-agent exchanging operation (and, if appropriate, cleaning of the connecting lines). This selection can be made via a man/machine interface, which comprises for example one or more actuation devices.

As an alternative or in addition to the above-explained advantageous configurations, the advantageous configurations and features explained in connection with the device according to the invention can be used in the method.

Further details and advantages of the invention will be explained below on the basis of the exemplary embodiments shown in the figures, in which:

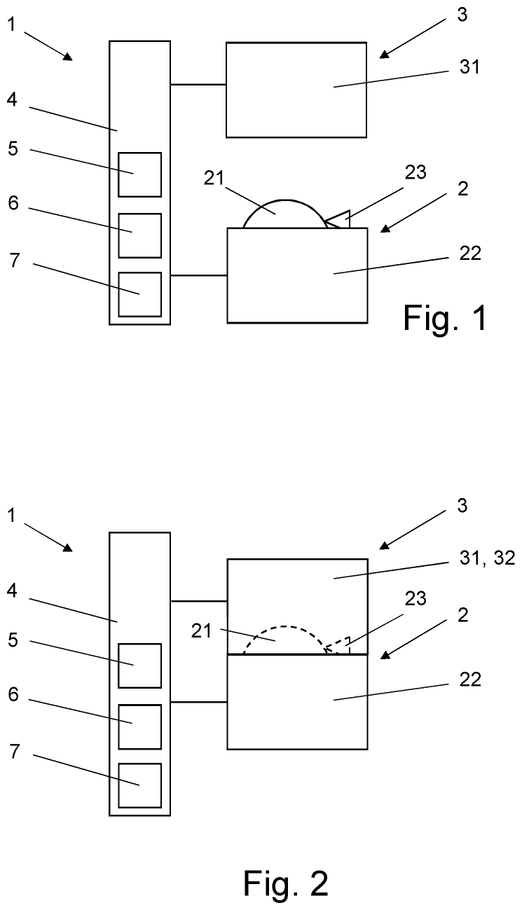

FIG. 1 shows a schematic illustration of an application apparatus according to a first exemplary embodiment of the invention, the application unit and the cleaning unit being in a production position;

FIG. 2 shows a schematic illustration of the application apparatus as per FIG. 1, the application unit and the cleaning unit being in a cleaning position;

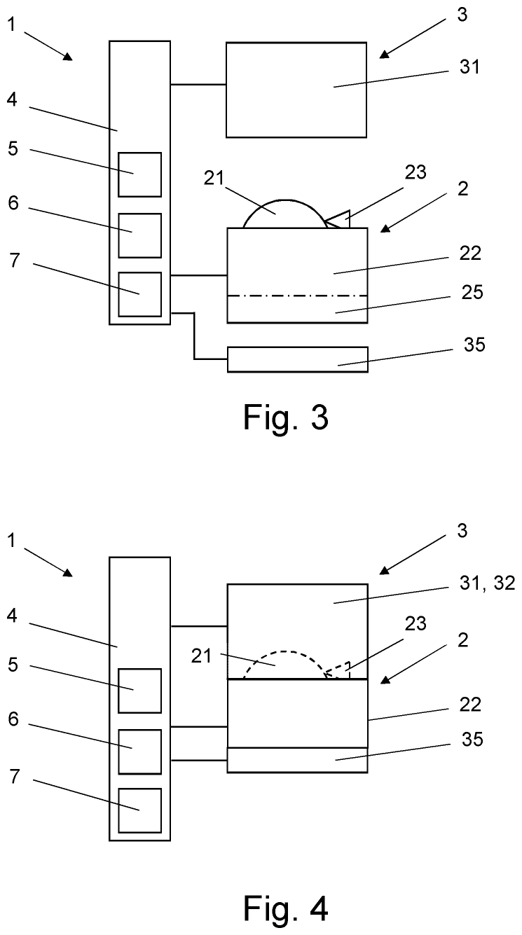

FIG. 3 shows a schematic illustration of an application apparatus according to a second exemplary embodiment of the invention, the application unit and the cleaning unit being in a production position;

FIG. 4 shows a schematic illustration of the application apparatus as per FIG. 3, the application unit and the cleaning unit being in a cleaning position;

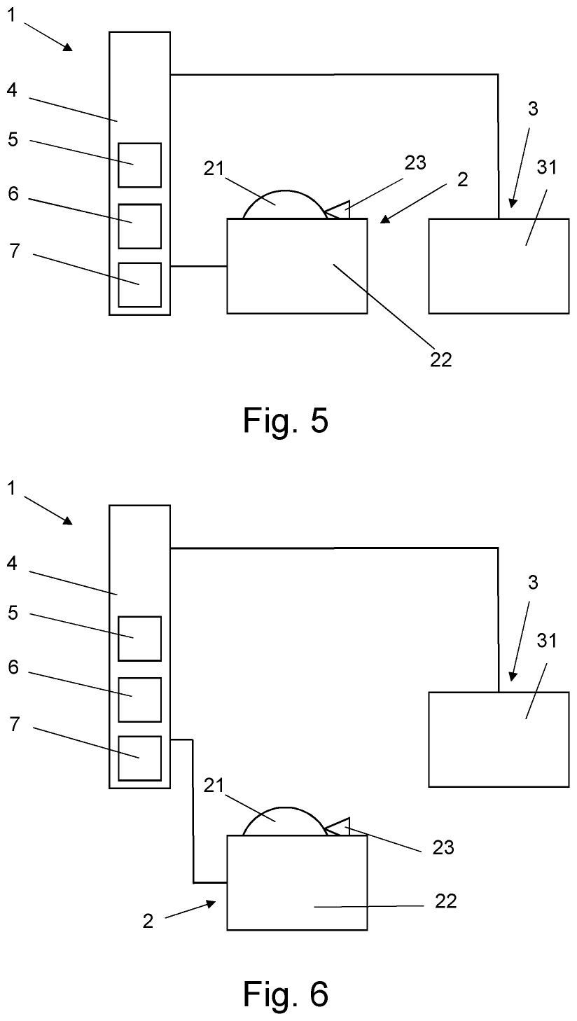

FIG. 5 shows a schematic illustration of an application apparatus according to a third exemplary embodiment of the invention, the application unit and the cleaning unit being in a production position;

FIG. 6 shows the application apparatus as per FIG. 5 in a first intermediate position;

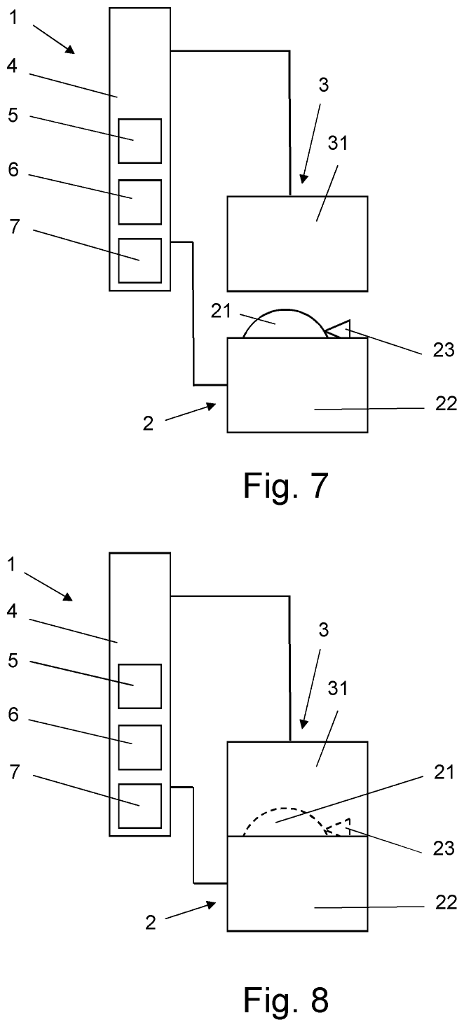

FIG. 7 shows the application apparatus as per FIG. 5 in a second intermediate position;

FIG. 8 shows a schematic illustration of the application apparatus as per FIG. 5, the application unit and the cleaning unit being in a cleaning position;

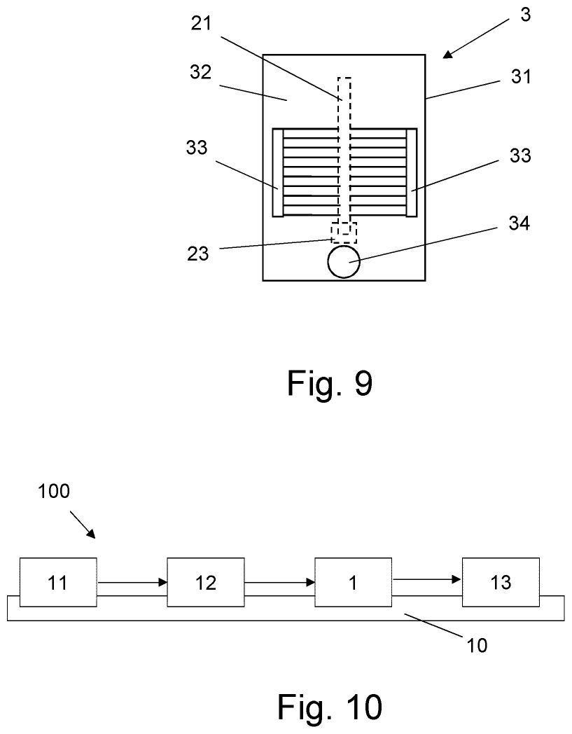

FIG. 9 shows a schematic plan view of the cleaning unit of the application apparatus as per FIG. 1;

FIG. 10 shows a schematic illustration of a production apparatus according to one exemplary embodiment of the invention; and

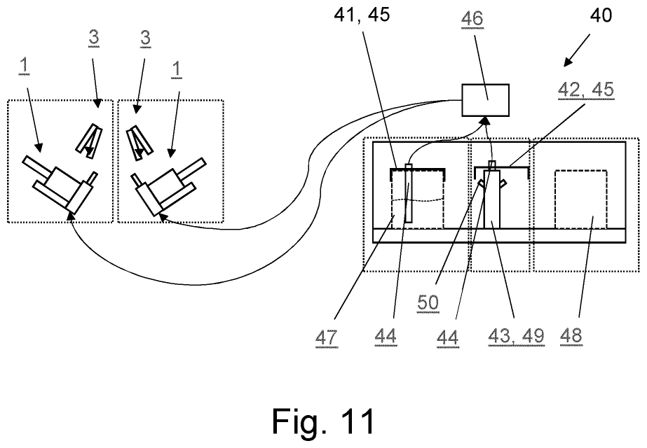

FIG. 11 shows a schematic illustration of an application apparatus comprising a supply unit according to one exemplary embodiment of the invention.

The illustration in FIG. 1 shows an application apparatus 1 according to an exemplary embodiment of the invention, it being possible for this application apparatus to be used in a production apparatus for floor elements in the form of floorboards, in order to apply coating agents or impregnation agents. The application apparatus 1 comprises an application unit 2 which is intended for applying the coating agent or impregnation agent and has a container 22 for the coating agent or impregnation agent and a transfer wheel 21 rotatably arranged in the container 22. The transfer wheel 21 takes up the coating agent or impregnation agent from the container 22 and transfers it contactlessly—i.e. via adhesion forces—to a portion of the respective floor element, for example to a joining surface or a chamfer. The floor element is guided past the transfer wheel 21 by a conveying apparatus, which is not shown in FIG. 1. A part of the transfer wheel 21, in particular a circular segment of the transfer wheel 21, protrudes out of an opening of the container 22 and can therefore transfer the coating agent or impregnation agent to the floor element. A further component of the application unit 2 is a scraper 23 for scraping coating agent or impregnation agent off of the transfer wheel 21. The scraper 23 is arranged within the container 22.

The container 22 comprises a side wall, which delimits the container opening, and a bottom which is fixedly connected to the side wall and is arranged on an oppositely situated end of the side wall to the container opening.

The application apparatus 1 also comprises a cleaning unit 3 comprising a hood 31 designed to cover the opening of the container 22 during a cleaning operation, the hood 31 having a receiving region 32 for receiving that part of the transfer wheel 21 that protrudes out of the container opening. According to FIG. 1, the cleaning unit 3 is at a spacing from the application unit 2. In this respect, the cleaning unit and the application unit 2 assume a production position, in which the application unit 2 can be used to apply a coating agent or impregnation agent.

A further component of the application apparatus 1 is a mount 4, on which the application unit 2 and the cleaning unit 3 are movably arranged. The application apparatus 1 also comprises a drive unit 5 for moving the drive unit 2 and the cleaning unit 3 relative to one another. The drive unit 5 makes it possible to move the application unit 2 and the cleaning unit 3 back and forth relative to one another between the production position shown in FIG. 1 and the cleaning position shown in FIG. 2.

The application apparatus 1 additionally comprises a triggering device 6 for triggering a movement of the application unit 2 and/or the cleaning unit 3 toward the cleaning position and a cleaning operation. This triggering device 6 is an actuation apparatus, which can be actuated manually by a user. Alternatively or additionally present may be an evaluation apparatus in the form of a triggering device 7, which is designed to detect a specified state, in particular a maintenance state, and trigger the cleaning whenever the specified state is detected.

According to FIG. 2, the application unit 2 and the cleaning unit 3 are in the cleaning position, in which the hood 31 of the cleaning unit 3 covers the container opening of the application unit 2. The transfer wheel 21 and the scraper 23 are arranged in the receiving space 32 of the hood 31. The hood 31 shields the transfer wheel 21 and the scraper 23 from the surrounding area such that they cannot be subjected to wet cleaning without adversely affecting the surrounding area. The cleaning unit 3 may be arranged lower down with respect to the direction of gravitational force in the cleaning position than in the production position. In this respect, the cleaning unit 3 may be brought from the production position into the cleaning position by way of an in particular linear movement in the direction of gravitational force. Optionally, it may be provided that the cleaning unit 3 is offset in a horizontal direction in the cleaning position in comparison with the production position, the horizontal direction being understood to mean a direction perpendicular to the direction of gravitational force. As an alternative or additionally, the application unit 2 may be arranged higher up with respect to the direction of gravitational force in the cleaning position than in the production position.

A further exemplary embodiment of an application apparatus 1 according to the invention is shown in FIG. 3. The application apparatus 1 corresponds substantially to the application apparatus shown in FIG. 1, and therefore reference is made to the explanations given in that respect. By contrast to the application apparatus 1 according to FIG. 1, in the case of the application apparatus as per FIG. 3 a container 22 having a bottom opening is provided.

Furthermore, a bottom 25 which can be opened to clear the bottom opening is provided on the container 22. The bottom may be arranged for example pivotably on the container 22, in particular on a side wall of the container 22. A further difference in relation to the exemplary embodiment shown in FIG. 1 is that the cleaning unit 3 has a bottom element 35 which can be moved independently of the hood 31 and is away from the application unit 2 in the production position shown in FIG. 3.

FIG. 4 shows the application apparatus 1 as per FIG. 3 in the cleaning position, in which the hood 31 of the cleaning unit 3 covers the container opening of the application unit 2 and the bottom element 35 of the cleaning unit 3 covers the bottom opening of the application unit 2.

The illustration in FIG. 5 shows a further exemplary embodiment of an application apparatus 1 according to the invention. The application apparatus 1 corresponds substantially to the application apparatus shown in FIG. 1, and therefore reference is made to the explanations given in that respect. By contrast to the application apparatus 1 according to FIG. 1, the application apparatus 1 as per FIG. 5 is designed to bring the application apparatus 2 and the cleaning apparatus 3 from the production position shown in FIG. 5 to a cleaning position shown in FIG. 8 in a different way. The movement sequence includes intermediate steps illustrated in FIGS. 6 and 7.

Proceeding from the production position as per FIG. 5, in a first movement step, first of all the application unit 2 is moved in such a way that the application unit 2 clears a space taken up by the application unit in the production position. After this first intermediate step has been completed, the application unit 2 and the cleaning unit 3 are in a first intermediate position, which is shown in FIG. 6. The movement from the production position into the first intermediate position can be effected for example in that the application unit 2 is moved downward in the direction of gravitational force. Such a configuration is suitable in particular for such use cases in which a conveying apparatus (not illustrated) is arranged above the application unit 2 and prevents the cleaning unit 3 from approaching the application unit 2 from above.

In a second movement step, the cleaning unit 3 is then moved into the space cleared by the application unit 2. The movement can be effected in a horizontal direction, which extends perpendicularly in relation to the direction of gravitational force. As a result of this movement, a second intermediate position, illustrated in FIG. 7, is reached.

In a subsequent third movement step, the application unit 2 is then moved up to the cleaning unit 3 such that the cleaning unit 3 and the application unit 2 assume a cleaning position, in which the hood 31 of the cleaning unit 3 covers the container opening of the application unit 2.

FIG. 9 shows a cleaning unit 3 which can be used in the above-described application apparatuses 1, in particular in the application apparatus 1 as per FIG. 1. The view of the cleaning unit 3 is selected such that it is possible to see into the interior of the hood 31, which is to say into the receiving region 32 of the hood 31. The transfer wheel 21 and the scraper 23 are illustrated in dashed line for the sake of better orientation. The figure shows that the receiving region 32 of the hood 31 contains two cleaning elements 33 in the form of brushes, which are arranged in such a way that that part of the transfer wheel 21 that protrudes out of the container opening is arranged between the two cleaning elements 33 when the hood covers the container opening in the cleaning position as per FIG. 2. In this position, a respective one of the two cleaning elements 33 can clean one of the two oppositely situated surfaces of the transfer wheel 21. The brushes are preferably in the form of brushes of the same type. A further cleaning element 34 in the form of a spray element is arranged in the receiving region 32 of the cleaning unit 3. This cleaning element 34 is arranged in such a way that it can clean the scraper 23 when the hood 31 covers the opening of the container 22 in the cleaning position. The spray element is preferably in the form of a rotatable spray element, such that it can discharge a cleaning liquid at an angle of 360°.

The illustration in FIG. 10 schematically shows a production apparatus 100 according to an exemplary embodiment of the invention, this production apparatus being in the form of a floor line, which is to say a production apparatus 100 for producing partially coated and/or partially sealed floor elements. The production apparatus 100 comprises an application apparatus 1 as per FIG. 1, 3 or 5, processing apparatuses 11, 12, 13 for processing the products, and a conveying device 10 for conveying the products from the processing apparatuses 11, 12 to the application apparatus 1 or for conveying the products from the application apparatus 1 to the processing apparatus 13. The processing apparatuses 11, 12, 13 may be in the form for example of a milling apparatus, in particular for milling a joining surface or a chamfer of the floor element, or of a drying apparatus, for example a continuous oven.

In the case of such production apparatuses 100, maintenance, cleaning or calibration of individual tools of the processing apparatuses 11, 12, 13 is only possible when the entire production apparatus 100 is at a standstill. An operator can in each case only work on one processing apparatus 11, 12, 13, or one tool of the production apparatus 100. In particular in the case of the application apparatus 1, during such standstill periods there is the risk of the coating agent or impregnation agent becoming dried on and the availability of the production plant 100 being reduced. While the application apparatus 1 is in operation, impurities that can block for example the scraper 23 accumulate in the coating agent or impregnation agent.

The production apparatus 100 shown overcomes this in that provided as part of a processing apparatus 11, 12, 13 that is provided separately from the application apparatus 1 is a triggering device, via which an operator working on the processing apparatus 11, 12, 13, for example for maintenance, repair or cleaning purposes, can trigger a movement of the application unit 2 and/or the cleaning unit 3 toward the cleaning position and a cleaning operation in the application apparatus 1 such that this cleaning operation can be carried out in parallel with the work performed by the operator on the processing apparatus 11, 12, 13. The triggering device may be an actuation apparatus, which can be actuated by the user, for example a switch or a pushbutton. As an alternative, the triggering device may be in the form of an evaluation apparatus, which is designed to detect a specified state, in particular a maintenance state, of the first processing device and thereupon trigger the cleaning of the application unit.

In this respect, the triggering devices of the processing apparatuses 11, 12, 13 make it possible to initiate an automatic cleaning of the application unit 2 of the application apparatus 1.

The production apparatus 100 can provide different cleaning modes, which are advantageous in particular for such configurations in which the application unit is coupled to a supply unit via one or more supply lines, via which the application unit is supplied with coating agent or impregnation agent and/or into which excess coating agent or impregnation agent is returned. For example, it is possible in a first cleaning mode for exclusively the application unit 2 to be cleaned by the cleaning unit 3 and for the supply unit not to be cleaned. This first cleaning mode is suitable as an intermediate cleaning, which can be carried out relatively quickly. Furthermore, it is possible to provide a second cleaning mode in which the application unit 2 is cleaned by means of the cleaning unit 3 and the supply unit is also cleaned. The second cleaning mode can provide a complete cleaning of the application unit 1, which is to say the application unit 2 and the supply unit. Ultimately, there is also the option of an automatic exchange of lacquer. While production is ongoing, on the supply unit, the new lacquer is made available to the unused lacquering station. As soon as the production of the filler has finished, the operator can trigger the exchange of lacquer via one of the actuation devices. Following that—while the operator ensures the remaining repositioning of the line—both the application unit 2 and the connecting line are cleaned by the cleaning unit 3. Then, the application unit is automatically filled with the new lacquer from the hitherto unused lacquering station and the production can start. During the new production, the operator can then push the previously used lacquering station into the cleaning tube and clean it.

Below, a cleaning operation on a supply unit 40 will be explained using the illustration in FIG. 11. The supply unit comprises a first suction unit 41 for drawing in a coating agent or impregnation agent from a first container 47 for medium, a second suction unit 42 for drawing in a coating agent or impregnation agent from a second container 48 for medium, and a cleaning station 43 for cleaning the first or second suction unit. The first and the second suction unit 41, 42 each comprise a suction lance 44 and a cover 45 for closing the respective container 47, 48 for medium. The cleaning station 43 has a receptacle 49 for the suction unit 41, 42, in particular for the suction lance 44 of the suction unit 42. Arranged in the region of the receptacle 49 are additionally one or more cleaning nozzles 50, via which a suction unit 41, 42 or suction lance 44 received in the receptacle 49 can be cleaned.

Before the cleaning operation on the supply unit 40 starts, the suction lance 42 of the respective suction unit 41, 42 is introduced into the receptacle 49 of the cleaning station 43. The suction lance 44 of the respective other suction unit 41, 42 can stay in the respective container for medium. After the cleaning operation starts, the suction lance 44 received in the receptacle 49 is cleaned by means of the cleaning nozzles 50 of the cleaning station 43. It is also possible to clean, in particular rinse, lines for medium that are present in the supply unit 40, for example lines for medium between a valve unit and the suction lance 44. After the suction unit 41, 42 has been cleaned, it can be taken out of the receptacle 49 and the respective other suction unit 41, 42 can be introduced into the receptacle 49 for cleaning purposes.

### REFERENCE SIGNS

1 Application apparatus
2 Application unit
3 Cleaning unit
4 Mount
5 Drive unit
6 Triggering apparatus
7 Triggering apparatus
10 Conveying apparatus
11 Processing apparatus
12 Processing apparatus
13 Processing apparatus
21 Transfer wheel
22 Container
23 Scraper
25 Bottom
31 Hood
32 Receiving region
33 Cleaning element
34 Cleaning element
35 Bottom element
40 Supply unit
41 Suction unit
42 Suction unit
43 Cleaning station
44 Suction lance
45 Cover
46 Valve unit
47 Container for medium
48 Container for medium
49 Receptacle
100 Production apparatus

1. An application apparatus comprising:
a) an application unit for applying a coating agent or impregnation agent, the application unit having a container for a coating agent or impregnation agent and a transfer wheel rotatably arranged in the container, wherein a part of the transfer wheel protrudes out of an opening of the container;
b) a cleaning unit, which includes a hood designed to cover the opening of the container during a cleaning operation, the hood having a receiving region for receiving that the part of the transfer wheel that protrudes out of the container opening; and
c) a drive unit and a mount, on which the application unit and the cleaning unit are arranged movably relative to one another by means of the drive unit;
wherein the application unit and the cleaning unit are movable relative to one another between a cleaning position, in which the hood of the cleaning unit covers the container opening of the application unit, and a production position, in which the hood of the cleaning unit is away from the container opening of the application unit

2. The application apparatus as claimed in claim 1, including a first triggering device for triggering a movement of the application unit and/or the cleaning unit toward the cleaning position,
the first triggering device being a first actuation apparatus, which can be actuated by a user, or a first evaluation apparatus, which is designed to detect a specified state.

3. The application apparatus as claimed in claim 1, wherein the receiving region of the hood contains two cleaning elements, which are arranged in such a way that the part of the transfer wheel that protrudes out of the container opening is arranged between the two cleaning elements when the hood covers the container opening, with a result that one of the two cleaning elements can clean a respective one of two oppositely situated surfaces of the transfer wheel.

4. The application apparatus as claimed in claim 3, wherein the two cleaning elements are in a form of brushes, or in that the two cleaning elements are in a form of spray elements.

5. The application apparatus as claimed in claim 1, wherein the application unit has a scraper for scraping a coating agent or impregnation agent from the transfer wheel, the scraper being arranged inside the container, wherein the cleaning unit has a further cleaning element that is arranged in the receiving region of the hood in such a way that it can clean the scraper when the hood covers the container opening.

6. The application apparatus as claimed in claim 5, wherein the further cleaning element for cleaning the scraper can be brought from a retracted inactive position into an extended cleaning position, with the further cleaning element in the cleaning position being arranged underneath or obliquely underneath; the scraper in a direction of gravitational force.

7. The application apparatus as claimed in claim 1, wherein the container of the application unit has a bottom opening and a bottom which can be opened to clear the bottom opening; and
wherein the cleaning unit, having a bottom element which can be moved independently of the hood, is away from the application unit in the production position; and covers the bottom opening in the cleaning position.

8. A production apparatus for producing at least partially coated and/or impregnated products, in particular floor elements, comprising:
a discharge apparatus according to claim 1; and
a first processing apparatus for processing the products;
a conveying apparatus for conveying the products from the first processing apparatus to the application apparatus or a conveying apparatus for conveying the products from the application apparatus to the first processing apparatus; and
a second triggering device as part of the first processing apparatus for triggering a movement of the application unit and/or the cleaning unit toward the cleaning position,
the second triggering device being a second actuation apparatus, which can be actuated by a user, or a second evaluation apparatus, which is designed to detect a specified state of the first processing apparatus.

9. The production apparatus as claimed in claim 8, including at least one second processing apparatus for processing the products, which has a third triggering device as part of the second processing apparatus for triggering a movement of the application unit and/or the cleaning unit toward the cleaning position, the third triggering device being a third actuation apparatus, which can be actuated by a user, or a third evaluation apparatus, which is designed to detect a specified state of the second processing apparatus.

10. The production apparatus as claimed in claim 8, wherein the application unit has a supply unit for supplying the application unit with a coating agent or impregnation agent.

11. The production apparatus as claimed in claim 10, wherein the application unit is connected to the supply unit via a supply line or via multiple supply lines.

12. The production apparatus as claimed claim 10,
wherein the application apparatus has a first triggering device for triggering a movement of the application unit and/or the cleaning unit toward the cleaning position, the first triggering device being a first actuation apparatus, which can be actuated by a user, or a first evaluation apparatus, which is designed to detect a specified state; and
wherein the production apparatus is designed to:
when the first triggering device is triggered, bring the application unit and/or the cleaning unit into the cleaning position, initiate a cleaning operation on the application unit, and initiate a cleaning operation on the supply unit, and/or initiate a coating-agent or impregnation-agent exchanging operation in the supply unit; and
when the second triggering device is triggered, bring the application unit and/or the cleaning unit into the cleaning position, initiate a cleaning operation on the application unit, and not initiate a cleaning operation on the supply unit.

13. A method for cleaning, by means of a cleaning unit, an application unit for applying a coating agent or impregnation agent,
the application unit comprising a container for the coating agent or impregnation agent and a transfer wheel rotatably arranged in the container, wherein a part of the transfer wheel protrudes out of an opening of the container;
the cleaning unit comprising a hood designed to cover the opening of the container during a cleaning operation, the hood having a receiving region for receiving has the part of the transfer wheel that protrudes out of the container opening;
the application unit and the cleaning unit being arranged movably relative to one another, the application unit and the cleaning unit being movable relative to one another from a production position, in which the hood of the cleaning unit is away from the container opening of the application unit, and a cleaning position, in which the hood of the cleaning unit covers the container opening of the application unit.

14. The method as claimed in claim 13, on transition into the cleaning position, the application unit is moved and the cleaning unit is not moved.

15. The method as claimed in claim 13, on transition into the cleaning position, the cleaning unit is moved and the application unit is not moved.

16. The method as claimed in claim 13, wherein the movement toward the cleaning position is triggered by a first actuation apparatus, which is actuated by a user, or by a first evaluation apparatus, which detects a specified state of the application apparatus and/or of a processing apparatus which, together with the application apparatus, is part of a common production plant for producing coated and/or impregnated products.

17. The method as claimed in claim 13, wherein the receiving region 3 of the hood contains two cleaning elements, which are arranged in such a way that the part of the transfer wheel that protrudes out of the container opening is arranged between the two cleaning elements when the hood covers the container opening, with a result that one of the two cleaning elements cleans a respective one of two oppositely situated surfaces of the transfer wheel.

18. The method as claimed in claim 13, wherein the application apparatus-has a supply unit for supplying the application unit with a coating agent or impregnation agent, a cleaning operation on the supply unit being initiated together with the movement of the application unit and of the cleaning unit relative to one another into the cleaning position.

19. The method as claimed in claim 13, wherein the application apparatus has a supply unit for supplying the application unit with a coating agent or impregnation agent, a coating-agent or impregnation-agent exchanging operation in the supply unit being initiated together with the movement of the application unit and of the cleaning unit relative to one another into the cleaning position.

20. The application apparatus as claimed in claim 1, wherein the part of the transfer wheel that protrudes out of the opening of the container is a circular segment of the transfer wheel.
